(19) United States
(12) Patent Application Publication
(10) Pub. No.: US 2013/0083389 A1
(43) Pub. Date: Apr. 4, 2013

(54) Laser Doppler Velocimeter Optical Electrical Integrated Circuits

(71) Applicant: Optical Air Data Systems, L.L.C., Manassas, VA (US)

(72) Inventors: Elizabeth A. DAKIN, Great Falls, VA (US); Priyavadan Mamidipudi, Great Falls, VA (US); Lance LeClair, Manassas, VA (US); Rupak Changkakoti, Haymarket, VA (US); Chia Chen Chang, Gaithersburg, MD (US); Daniel Dakin, Great Falls, VA (US)

(73) Assignee: Optical Air Data Systems, L.L.C., Manassas, VA (US)

(21) Appl. No.: 13/628,704

(22) Filed: Sep. 27, 2012

Related U.S. Application Data
(60) Provisional application No. 61/541,884, filed on Sep. 30, 2011.

(51) Int. Cl. H01S 3/067; G02F 1/11; G02F 1/01

(52) U.S. Cl. 359/285; 359/341.1; 359/240

(57) ABSTRACT

A photonic integrated circuit and related method are presented. A photonic integrated circuit comprises a source of radiation, one or more optical amplifiers, a transceiver, and optical waveguides. The optical waveguides couple light between the source of radiation, the one or more optical amplifiers, and the transceiver. The one or more optical amplifiers are configured to increase an optical power of the light up to at least 10 mW. The photonic integrated circuit may be used to perform laser Doppler velocimeter type measurements.

### BACKGROUND

1. Field of the Invention

This disclosure relates to a system and a method to arrange optical components on a integrated circuit board, for example a laser doppler velocimeter (LDV) photonic integrated circuit (PIC).

2. Background Art

Similar to the transition from vacuum tubes to transistors to integrated circuits in electronic devices, optical components are becoming miniaturized through integration of components onto circuit boards. Currently, most of the development of optical component integrated circuits is being done in the telecommunications industry for a limited number of components and limited types of components. Additionally, light energy utilized for the telecommunications industry operates orders of magnitude below light energies used for what is needed in an LDV PIC. Consequentially, current telecommunications PICs would be destroyed if they were used to transmit light energies occurring in LDV environments.

### SUMMARY

Therefore, what is needed are new manufacturing technologies and designs for optical components for a PIC operating configured as a LDV.

An embodiment of the present invention provides a photonic integrated circuit comprising a source of radiation, one or more optical amplifiers, a transceiver, and optical waveguides. The optical waveguides couple light between the source of radiation, the one or more optical amplifiers, and the transceiver. The one or more optical amplifiers are configured to increase an optical power of the light up to at least 10 mW.

Another embodiment of the present invention provides a method. The method includes modulating a coherent light beam transmitted through a first on-chip waveguide from an on-chip pulsed laser source containing one or more frequencies. The modulating includes amplifying the power of the coherent light beam to at least 10 mW. The method continues with transmitting the modulated light beam through a second on-chip waveguide to a target region off-chip. The method further includes receiving one or more scattered light beams from the target region through a third on-chip waveguide. The method includes combining the received scattered light beams with one or more reference light beams received through a fourth on-chip waveguide from the on-chip pulsed laser source. The method concludes with determining a Doppler shift based on a difference between the one or more scattered light beams and the one or more reference light beams.

Further features and advantages of the present invention, as well as the structure and operation of various embodiments of the present invention, are described in detail below with reference to the accompanying drawings. It is noted that the present invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWING(S)/FIGURE(S)

The accompanying drawing(s), which are incorporated herein and form part of the specification, illustrate the present invention and, together with the description, further serve to explain the principles of the invention and to enable a person skilled in the relevant art(s) to make and use the invention.

FIG. 1 shows a photonic integrated circuit, according to an embodiment of the present invention.

FIG. 2 shows a transceiver module with multiple outputs, according to an embodiment of the present invention

The features and advantages of the present invention will become more apparent from the detailed description set forth below when taken in conjunction with the drawings, in which like reference characters identify corresponding elements throughout.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION

This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “one embodiment,” “an embodiment,” “an example embodiment,” etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure; or characteristic is described in connection with an embodiment, it is understood that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

Before describing such embodiments in more detail, however, it is instructive to present an example environment in which embodiments of the present invention may be implemented.

LIDAR systems, such as laser Doppler velocimeters (“LDVs”), transmit light to a target region (e.g., into the atmosphere) and receive a portion of that light after it has scattered or reflected from the target region or scatterers in the target region. This received light is processed by the LDV to obtain the Doppler frequency shift, f_{D}. The LDV conveys the velocity of the target relative to the LDV, v, by the relationship v=(0.5)cf_{D}/fₜ where fₜ is the frequency of the transmitted light, and c is the speed of light in the medium between the LDV and the target. LDV's are have a wide range of applications including, but not limited to: blood-flow measurements, speed-limit enforcement, spaceship navigation, projectile tracking, and air-speed measurement. In the latter case the target consists of aerosols (resulting in Mie scattering), or the air molecules themselves (resulting in Rayleigh scattering).

Example systems and methods that may be implemented on a optical integrated circuit include those disclosed in U.S. Pat. Nos. 5,272,513, 6,141,086, 7,068,355, 7,206,064, 7,898,435, 8,190,030, U.S. application Ser. Nos. 10/581,416, 10/771,310, 10/969,964, 12/988,248, 13/026,932, 13/116,621, 13/396,313, 13/475,536, 13/475,580, 13/476,637, 13/477,454, 13/478,025, 13/484,565, and Published PCT Appl. No. WO2009/134221. which are all incorporated by reference herein in their entireties.

Other exemplary optical integrated circuit systems, which are all incorporated by reference in their entireties, are those discussed in Smit et al. “Photonic integrated circuits: where are the limits?” COBRA Research Institute, Technische Universiteit Eindhoven, Postbus 512, 5600 MB Eindhoven, the Netherlands, Larry A. Coldren “InP Based Photonic Integrated Circuits,” CLEO '08 Tutorial, CTuBB1, ECE and Materials Departments, University of California, Santa Barbara, Calif. 93106, Ivan P. Kaminow “Photonic Integrated Circuits: A Personal Perspective,” Oct. 3, 2007, NICTA SEMINAR Melbourne, Brian Welch, Technical Marketing Engineer, Luxtera, NASA Technical Briefs “Demystifying Electro-Photonic Integrated Circuits,” Saturday May 1, 2010 and being developed by European Manufacturing Platform for Photonic Integrated Circuits, VLC Photonics S.L., and Freedom Photonics LLC.

For example, an exemplary optical system disclosed in these patents and applications include a transmission path including a source, a modulator, one or more amplifiers, a transceiver and a receiving path including the transceiver, a coupler coupling a portion of the source beam and a received beam, a photodetector, and a processor. Each of these components is formed in a photonic integrated circuit, as discussed in more detail below. Additionally, as compared to present telecommunications systems, the components in embodiments of the present invention can be specifically manufactured and arranged to accommodate the higher light energies needed for, e.g., LDV systems, as compared to the lower light energies, e.g., one to three order of magnitude lower, for telecommunication systems.

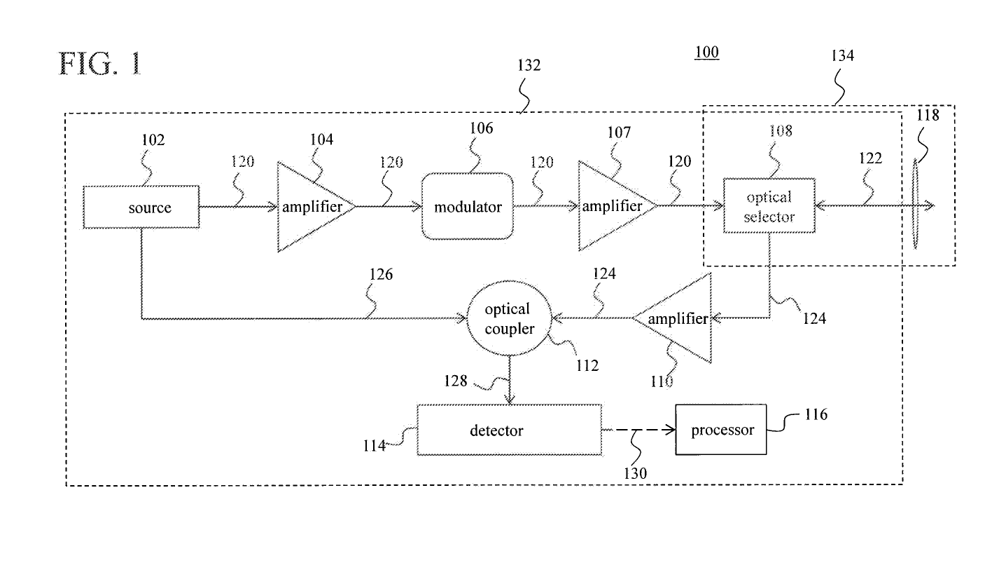

FIG. 1 shows a photonic integrated circuit (PIC) 100, according to an embodiment of the present invention. For example, a LIDAR or LDV PIC. PIC 100 includes an optical source 102, an amplifier 104, a modulator 106, an amplifier 107, an amplifier 110, an optical coupler 112, a detector 114, a processor 116, and a transceiver 134 further comprising: an optical selector 108, and an optical element 118, e.g., a lens. Between these elements are optical light guides 120, 122, 124, 126, and 128 discussed in more detail below.

It can be appreciated that, although three amplifiers are shown, amplifiers 104, 107, and 110, they may be optional depending on the amplitude of a sample signal from source 102. Thus, in various embodiment, any of the amplifiers may not be in the paths shown. In one example, amplifiers 104, 107, and 110 can be semiconductor optical amplifiers (SOA). It should also be understood that modulator 106 may also act as an amplifier, and thus can be defined similarly to any of amplifiers 104, 107, and 110.

In one example, source 102 produces radiation at 1064 nm. In another example, source 102 produces radiation at 1550 nm. Other wavelengths are also contemplated within the scope of the present invention.

In various examples, the optical selector 108 can be, but is not limited to, an optical circulator or an optical switch.

In one example, modulator 106 can be an acousto-optic modulator (AOM).

In one example, the light transmitted from source 102 is polarized.

In one example, source 102 can be a laser source, e.g., a laser diode. In one example, source 102 can generate light in a wavelength range of 1.0 to 1.5 μm. Source 102 may be a pulsed laser source.

In one example, the optical light guides 120, 122, 124, 126, and 128 can be optical waveguides that are etched within a substrate 132, on which photonic integrated circuit 100 is manufactured. For example, substrate 132 can be made from indium phosphide.

Known lithography techniques can be used to etch the light guides into the substrate and form the source, amplifiers, modulator, coupler, circulator, and detector on the substrate.

Guide 120 provides a path for sample light, generated by source 102, between source 102 and optical selector 108 along a path comprising amplifier 104, and modulator 106. Guide 122 provides a path for output light through the optical element 118 and for scattered light received through the optical element 118. Guide 124 provides a path for scattered light between optical selector 108 and coupler 112 along a path comprising amplifier 110. Guide 126 provides a path for reference light between source 102 and coupler 112. Guide 128 provides a path for signal light between coupler 112 and detector 114.

In one example, detector 114 provides a signal 130, e.g., representative of the mixed reference light and scattered light, to processor 116.

In one example, the sample light is directed from source 102 into amplifier 104. This can be done to increase the signal strength. After passing through amplifier 104, the sample light passes through modulator 106, e.g., to alter a frequency of the sample light. The sample light then passes through amplifier 107 to further increase the signal amplitude following modulation. The sample light is directed through optical selector 108 and becomes output light. The output light is then directed to the optical element 118, from which the output light is directed onto a target region off chip.

In one example, the scattered light from the target region is collected by the optical element 118 and directed through circulator 108. Circulator 108 directs the scattered light towards amplifier 110, e.g., to increase the signal strength of the scattered light. Coupler 112 combines the scattered light with the reference light from source 102. For example, the two light waves are combined in such a way that they have the same polarization and occupy the same space. After combining, coupler 112 transmits the signal light directed to detector 114.

In one example, detector 114 produces an electrical signal, which includes a component whose frequency is the mathematical difference between the frequency of the reference light and the scattered light.

In one example, the electrical signal is received by processor 116. For example, processor 116 analyzes the electrical signal to determine the frequency difference and calculate the relative velocity component of particles in the target region.

It can be appreciated that optical selector 108 may be optional in an embodiment where the sample light is directed to a first optical element through a first guide and scattered light is collected from a second optical element through a second guide.

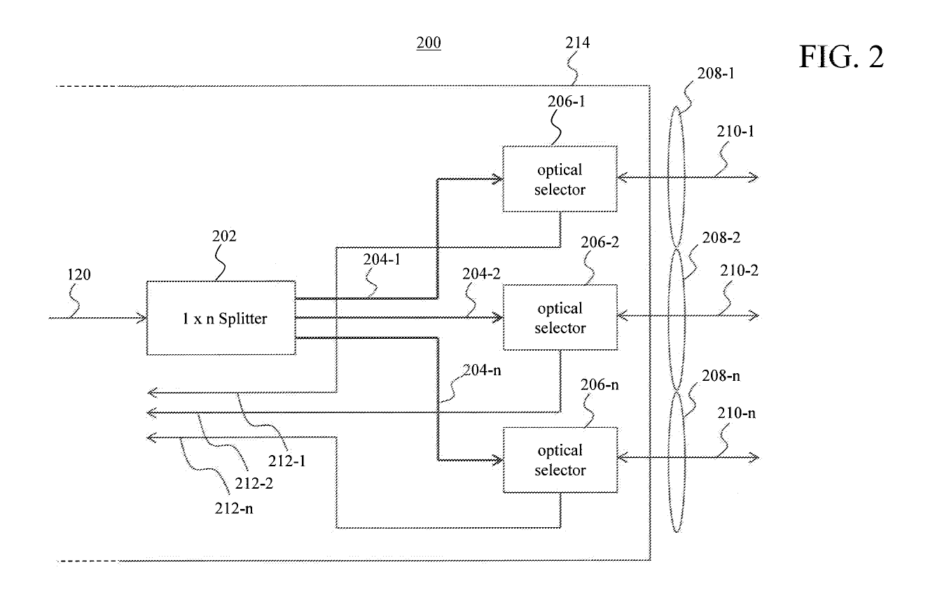

FIG. 2 illustrates a transceiver module 200 for providing more than one output light to be directed onto a target region off-chip, according to one embodiment of the present invention. The transceiver module 200 includes a splitter 202, one or more optical selectors 206-1 to 206-n, and one or more optical elements 208-1 to 208-n. Between these elements are optical light guides 204-1 to 204-n, 210-1 to 210-n and 212-1 to 212-n etched in a substrate 214.

In various examples, the optical selectors 206-1 to 206-n can be, but are not limited to, optical circulators or optical switches.

It is to be appreciated the configuration and number of optical elements and splitters can vary, such that optical elements and splitters may not be needed in certain configurations. For example, module 200 can function with just optical selectors 206 or just splitter 202. All variations are contemplated within the scope of the present invention.

In one example, splitter 202 can be a 1×n splitter, splitting a beam received from optical light guide 120 into n beams along light guides 204-1 to 204-n.

It can be appreciated that the splitter 202, may also be replaced with any number of switches, for example, a demultiplexer. In an embodiment, the demultiplexer can be coupled to a single circulator via light guide 120 which provides a path to light guide 124 for any scattered light collected from any light guide 210-1 to 210-n.

In one example, the optical light guides 120, 204-1 to 204-n, 210-1 to 210-n and 212-1 to 212-n can be optical waveguides etched in a substrate 214.

It can be appreciated that substrate 214 is a portion of the substrate 132 and both are of the same material.

Guide 120 provides sample light to the splitter 202. Guides 204-1 to 204-n provide output light from the splitter 202 to each of optical selectors 206-1 to 206-n. Guides 210-1 to 210-n provide output light from each optical element through each of the optical elements 208-1 to 208-n and collect scattered light returning from the sample through the optical elements 208-1 to 208-n to each of the optical selectors 206-1 to 206-n. Guides 212-1 to 212-n provide paths for the scattered light to one or more additional optical modules (not shown).

It can be appreciated that this is merely one example of an entire electrical and optical system that may be configured as an integrated circuit arrangement. Other configurations, arrangements, and types of optical and electrical components are also contemplated.

Embodiments of the present invention covers integration of optical and electrical components together on a same chip for the purpose of performing LDV or other light based measurements. Optical components can include, but are not limited to, patterned waveguides, photodetectors, modulators, circulators and splitters/combiners. These optical components can be etched onto a semiconductor substrate to facilitate the integration of both passive and active electrical components with the optical components. Designs may monolithically integrate an active light or laser source (or multiple sources) as well. Other components may include semiconductor optical amplifiers (SOA), control electronics and a microprocessor for handling collected data.

In one example, amplification of one or more transmitted optical signals is performed in order to increase signal-to-noise ratio of received signals.

In one example, a chip can receive power from an off-chip source and a separate lens may be aligned with the chip for light focusing onto the input/output waveguide facet.

In various embodiments, benefits of integration of each optical and electrical component onto the same chip include: reduced form factor, lower power consumption, lower manufacturing cost, and robustness.

The patterned waveguides used within a PIC (photonic integrated circuit) or PLC (planar lightwave circuit) may include material with a high refractive index core surrounded by a lower refractive index cladding. The index mismatch causes a majority of the energy from a propagating EM wave to remain guided within the core. LDV technology predominately uses near IR wavelengths and the types of waveguide materials best suited for this wavelength range include silicon and III-V materials such as indium phosphide (InP) or gallium arsenide (GaAs).

Silicon-on-insulator (SOI) wafers may be used to fabricate waveguides for photonic circuits. The waveguides are patterned in the top silicon layer and either remain on top of the underneath insulating layer (silicon dioxide), or the insulating layer may be removed leaving the silicon waveguides suspended with an air cladding on all sides. Silicon has a high index of refraction (3.42) while both silicon dioxide (1.47) and air (1) are substantially lower leading to a highly guided energy mode. Etching the silicon is typically performed via a deep reactive ion etching (DRIE) process tuned to minimize sidewall roughness in order to reduce light scattering.

One potential drawback to silicon waveguides is that the substrate material does not have a direct energy bandgap and thus will not produce light upon recombination of electron-hole pairs. Materials such as InP or GaAs have a direct energy band gap and thus can incorporate active optical sources such as a laser. Sacrificial layers made of tertiary materials (such as indium gallium arsenide, InGaAs) can be epitaxially grown beneath the waveguide layer and removed to suspend such waveguides and provide an all-air cladding. Both InP (3.1) and GaAs (3.0) have a high index of refraction in the near IR range. The integration of a monolithic active optical source on the LDV chip would require the use of a III-V material such as InP or GaAs, but a first demonstration of the chip using a hybrid integration scheme of the laser source can be performed in silicon.

In one example, the LDV chip can incorporate a laser diode as the active optical source. The laser diode is formed as a doped p-n junction in a semiconductor material with patterned electrodes for injecting charged carriers into the depletion region. The direct energy bandgap of III-V semiconductor materials allows the recombination of the generated charged carriers to produce light. When a certain threshold of electron-hole pairs is reached, the light emission transitions from spontaneous emission to stimulated emission and lasing occurs. The light is typically amplified further within an etched optical cavity between two highly reflective waveguide facets.

In one example, the LDV chip also incorporates a photodetector to collect a mixed signal of the scattered light returned from the sample and a reference light provided on chip. The detector is a transducer for converting the optical signal into an electrical signal. A typical p-i-n photodetector comprises of an intrinsic region (used to extend the depletion region) sandwiched between two oppositely doped regions. When light of a particular wavelength range (depending on the material used) is incident on the intrinsic region, electron-hole pairs are created and swept towards either of the outer two doped regions. This movement of charge produces a current which is measured in a simple circuit. For the LDV chip, the photodetector may be fabricated to utilize the sacrificial insulating layer as the intrinsic region and allow light propagating in the waveguide to leak down into this region as it passes over the detector. Electrical contacts made to both of the doped regions would be used to measure the AC current produced.

In one example, optical modulators are incorporated onto the LDV chip. These modulators are used to control the refractive index of the waveguide material and can alter the polarization, phase, frequency and amplitude of the signal. For the LDV application, modulation is required for: amplification of the laser source before transmission or to amplify the returned signal before entering the optical coupler and frequency shifting of the laser source to facilitate determination of the direction of any detected motion from the sample. Modulation is commonly employed through the application of an electric field across a crystal waveguide section which alters the index of refraction and can cause changes to the phase or frequency of the signal. The amplitude can be increased or decreased by splitting the incident beam into two paths and modulating the phase of one path, then recombining the two. A semiconductor optical amplifier (SOA) can be incorporated to increase the amplitude of the optical signal via electrical pumping of a gain region similar to a laser, but without a reflecting optical cavity. The frequency shifting can be performed via acoustic waves, or through the application of an AC electric field.

In an embodiment, the various optical modulators included on the LDV chip would be designed to increase the power of the optical signal up to at least 10 mW. The high power output may be used for performing LDV type measurements to ensure that the return signal has enough power to be adequately detected. Presently, e.g., telecommunications photonic integrated circuits are only capable of amplifying the optical power within the microwatt range. Electrical breakdown typically occurs due to the small length scales if higher power increases are attempted. However, the design and implementation of the present invention as described herein should overcome these limitations and achieve optical powers in the milliwatt range on a photonic integrated circuit.

In one example, optical splitters, combiners and couplers (also called circulators) are commonly employed to branch and combine light amongst more than just one path. Two waveguides which either diverge or merge together can be used to split or combine the light amongst the paths provided that the curvature of the waveguides is low. For the present LDV chip application, an example of the optical coupler is a 2×2 coupler which allows light to be combined between the scattered light from the sample and a reference light source. Two output waveguides result from the coupler which contain beams of opposite phase. The combination of the light beams can be performed via merging of the waveguide cores, or through evanescent coupling between two closely adjacent waveguides. When light propagates down the core of a waveguide, a low energy evanescent field will extend a short distance away from the core and into the cladding. This field can couple into the core of another waveguide if it is close enough.

In one example, optical switches are commonly used in the telecomm industry and may be used in the design of the LDV chip to switch the path of the light that is either transmitted out by the lens or received by the lens back to the LDV chip. The switches can be mechanical in which the input suspended waveguide is physically moved to align with a number of possible output suspended waveguides. The movement is typically only on the order of microns for on-chip waveguides limiting the number of switchable outputs. The movement can be performed with comb-drive actuators or by electrostatic forces where a voltage is applied between the waveguide and the substrate material to pull the two closer together. However, switching techniques also exist which do not require any mechanical movement which may be more optimal for the LDV on a chip. The thermo-electric effect can be used to alter the refractive index of a waveguide path, preventing light from propagating. This effect is provided by a patterned electrode very near to the waveguide which provides heat from the passage of current.

In one example, optical circulators can be used instead of optical switches. Circulators are passive optical elements which act as signal routers capable of transmitting light from a first port to a second port, but directing returning light to a third port. Optical circulators typically direct the light based on the light's polarization state.

The integration of electrical components within the PIC substrate is highly desirable for reasons including: lower noise, lower total form factor of the device, and lower material cost. Silicon is the ideal choice for electronics integration due to its good mechanical properties, high electron and hole mobility rates, and fabrication procedure which can produce a highly ordered lattice with few defects. While it is possible to monolithically incorporate electronics with other substrate materials such as the aforementioned III-V materials, a lower switching speed and higher fabrication complexity make the integration of electronics with these materials a more difficult task. In some examples, active electrical components are fabricated on an ASIC chip separately from the optical components and are integrated through techniques such as flip-chip bonding.

Although the primary application for this technology would be for wind sensing (speed and direction) as well as for the detection of airborne particles, other applications of interest include police RADAR guns, automobiles for controlling the speed of the car and military UAVs.

While specific embodiments of the present invention have been described above, it will be appreciated that the present invention may be practiced otherwise than as described. The description is not intended to limit the present invention.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the present invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, the Examiner is also reminded that any disclaimer made in the instant application should not be read into or against the parent application.

What is claimed is:

1. A photonic integrated circuit comprising:
a source of radiation;
one or more optical amplifiers;
a transceiver; and
optical waveguides, wherein the optical waveguides couple light between the source of radiation, the one or more optical amplifiers, and the transceiver, and wherein the one or more optical amplifiers are configured to increase an optical power of the light up to at least 10 mW.

2. The photonic integrated circuit of claim 1, wherein the source is a pulsed laser source.

3. The photonic integrated circuit of claim 2, wherein the pulsed laser source generates light in a wavelength range between 1.0 and 1.5 μm.

4. The photonic integrated circuit of claim 2, wherein the pulsed laser source generates polarized light.

5. The photonic integrated circuit of claim 1, wherein the transceiver comprises one or more optical elements.

6. The photonic integrated circuit of claim 5, wherein the one or more optical elements comprise one or more lenses configured to transmit and receive light.

7. The photonic integrated circuit of claim 1, wherein the source of radiation, the one or more optical amplifiers, the transceiver, and the optical waveguides are monolithically integrated within the same substrate.

8. The photonic integrated circuit of claim 7, wherein the substrate is selected from the group consisting of silicon, indium phosphide, and gallium arsenide.

9. The photonic integrated circuit of claim 1, wherein the one or more optical amplifiers comprise a semiconductor optical amplifier.

10. The photonic integrated circuit of claim 1, further comprising an optical modulator configured to alter a refractive index of a material through which the light traverses.

11. The photonic integrated circuit of claim 10, wherein the optical modulator comprises an acousto-optic modulator.

12. The photonic integrated circuit of claim 1, further comprising one or more optical selectors configured to direct the path of incoming light.

13. The photonic integrated circuit of claim 12, wherein the one or more optical selectors comprise an optical circulator.

14. The photonic integrated circuit of claim 1, further comprising a processing device for determining a Doppler shift between at least two beams of light.

15. The photonic integrated circuit of claim 1, wherein the source of radiation, one or more amplifiers, transceiver, and optical waveguides are a portion of a laser Doppler velocimeter.

16. A method comprising:
modulating a coherent light beam transmitted through a first on-chip waveguide from an on-chip pulsed laser source containing one or more frequencies, wherein the modulating further comprises amplifying the power of the coherent light beam to at least 10 mW;
transmitting the modulated light beam through a second on-chip waveguide to a target region off chip;
receiving one or more scattered light beams from the target region through a third on-chip waveguide;
combining the received scattered light beams with one or more reference light beams received through a fourth on-chip waveguide from the on-chip pulsed laser source; and
determining a Doppler shift based on a difference between the one or more scattered light beams and the one or more reference light beams.
